(19) United States
(12) Patent Application Publication
(10) Pub. No.: US 2021/0023551 A1
(43) Pub. Date: Jan. 28, 2021

(54) FLUID HANDLING DEVICE

(71) Applicant: Enplas Corporation, Saitama (JP)

(72) Inventor: Seiichiro SUZUKI, Saitama (JP)

(73) Assignee: Enplas Corporation, Saitama (JP)

(21) Appl. No.: 17/040,994

(22) PCT Filed: Mar. 25, 2019
(86) PCT No.: PCT/JP2019/012308

§ 371 Date: Sep. 24, 2020

(30) Foreign Application Priority Data
Mar. 27, 2018 (JP) 2018-059925

(51) Int. Cl. B01L 3/00

(52) U.S. Cl. CPC B01L 3/502; G01N 15/1056

(57) ABSTRACT

A fluid handling device according to the present invention is a fluid handling device for arranging a plurality of particles in one column while separating the particles from one another, to recover the same from a mixed solution in which the plurality of particles are collected in a surface layer or a bottom layer of a liquid. The fluid handling device according to the present invention comprises: an immersed portion for immersion in the liquid; a particle intake port opening in a surface of the immersed portion; a liquid intake port opening in a surface of the immersed portion; a particle flow passage; a liquid flow passage; a merging portion where the particle flow passage and the liquid flow passage merge; and a merged flow passage disposed downstream of the merging portion.

### TECHNICAL FIELD

The present invention relates to a fluid handling device.

### BACKGROUND ART

For various inspections and researches, amplification of a specific region of DNA by polymerase chain reaction (hereinafter, also referred to as “PCR”) is conventionally performed. PCR usually includes a step of denaturing DNA into single strands, a step of annealing a primer to a desired region of the DNA, and a step of elongating the DNA with a polymerase. Performing one cycle of these steps doubles the number of specific regions of the DNA, and theoretically, n cycles of the reaction increases the number to 2ⁿ times.

In recent years, a technique referred to as digital PCR is proposed as a method for specifying the amount of DNA fragments or RNA fragments contained in cells. The digital PCR sufficiently dilutes a sample and separates the diluted solution into a large number of liquid drops (hereinafter, also referred to as “droplets”). Droplets containing only one DNA fragment (or cDNA fragment) and droplets containing no DNA fragment are generated in the above procedure. When PCR is performed on these droplets, DNA is amplified only in the droplets containing the desired DNA fragment or RNA fragment. Confirming by a detection part whether or not the DNA in the droplets is amplified thus can specify the amount of the specific DNA fragments or RNA fragments contained in the sample.

For confirming the presence or absence of the amplification of the DNA with the detection part, the droplets are generally allowed to flow to the detection part while being separated from each other. In order to allow the droplets to flow while being separated from each other, a method in which droplets contained in a container are sampled with a pipette and transferred to a chip having a channel that allows the droplets to flow through is used. Another method is also used, in which a glass tube such as a capillary is inserted into a container to suck up droplets in a liquid stored in this container and move the droplets to a chip. However, sucking up droplets with a pipette is more likely to break or lose the droplets, and thus it is difficult to accurately determine the amount of the DNA fragments or the RNA fragments. In addition, sucking up the droplet and moving the droplets to the chip with a capillary requires connecting of the capillary to the chip by using another part. The above method thus requires complicated work, and a device used in the method is more likely to become large.

A device and system is proposed in which droplets are sucked from a container with a suction nozzle attached to the device and taken into the channel where a liquid flows, thereby arranging the droplets in a line and continuously transporting the droplets to a detection position while the droplets are separated from each other (see Patent Literature (hereinafter also referred to as “PTL”) 1).

### CITATION LIST

### Patent Literature

### PTL 1

### Japanese Unexamined Patent Application Publication (Translation of PCT Application) No. 2013-524170

### SUMMARY OF INVENTION

### Technical Problem

The droplet transport system disclosed in PTL 1 has a plurality of channels and a controller along a channel for transporting the droplets in addition to a controller for collecting the droplets, and thus the device constituting the system is disadvantageously large. In addition, as the channel that allows the droplets to flow is long, a large amount of liquid is required for allowing the droplets to be arranged in a line and flow while being separated from each other, thus increasing the cost.

An object of the present invention is to provide a small-sized fluid handling device capable of reducing the amount of a new liquid to be used, and the fluid handling device is for, from a mixed liquid with particles gathered in a surface layer or a bottom layer of a liquid, arranging the particles in a line and allowing the particles to flow while the particles are separated from each other.

### Solution to Problem

A fluid handling device according to the present invention is used for, from a mixed liquid with particles gathered in a surface layer or a bottom layer of a liquid, arranging the particles in a line and allowing the particles to flow while the particles are separated from each other, the fluid handling device including: an immersion part to be immersed in the liquid; a particle intake port for taking in the particles, the particle intake port opening onto a surface of the immersion part; a liquid intake port for taking in the liquid, the liquid intake port opening onto the surface of the immersion part; a particle channel for allowing the particles taken in from the particle intake port to flow; a liquid channel for allowing the liquid taken in from the liquid intake port to flow; a junction of the particle channel and the liquid channel; and a joining channel for allowing the particles to flow in a state where the particles are arranged in the line, the joining channel being disposed downstream of the junction, in which: the particle intake port and the liquid intake port are disposed at different positions in a vertical direction when the immersion part is immersed in the liquid.

### Advantageous Effects of Invention

The present invention can provide a small-sized fluid handling device capable of reducing the amount of a liquid to be used.

### BRIEF DESCRIPTION OF DRAWINGS

FIGS. 1A and 1B illustrate a fluid handling device according to embodiment 1 of the present invention;

FIGS. 2A to 2C illustrate the fluid handling device according to embodiment 1;

FIG. 3 illustrates the usage state of the fluid handling device according to embodiment 1;

FIG. 4 is a partially enlarged view illustrating the usage state of the fluid handling device according to embodiment 1;

FIG. 5 illustrates a fluid handling device according to embodiment 2 of the present invention;

FIGS. 6A to 6C illustrate the fluid handling device according to embodiment 2;

FIG. 7 is a partially enlarged view illustrating the usage state of the fluid handling device according to embodiment 2;

FIG. 8 is a partially enlarged view illustrating the usage state of a fluid handling device according to embodiment 3;

FIG. 9 is a partially enlarged view illustrating the usage state of a fluid handling device according to embodiment 4;

FIG. 10 is a partially enlarged view illustrating the configuration of a fluid handling device according to a modification; and

FIG. 11 is a partially enlarged view illustrating the configuration of a fluid handling device according to another modification.

### DESCRIPTION OF EMBODIMENTS

Hereinafter, embodiments of the present invention will be described in detail with reference to the drawings.

### Embodiment 1

(Configuration of Fluid Handling Device)

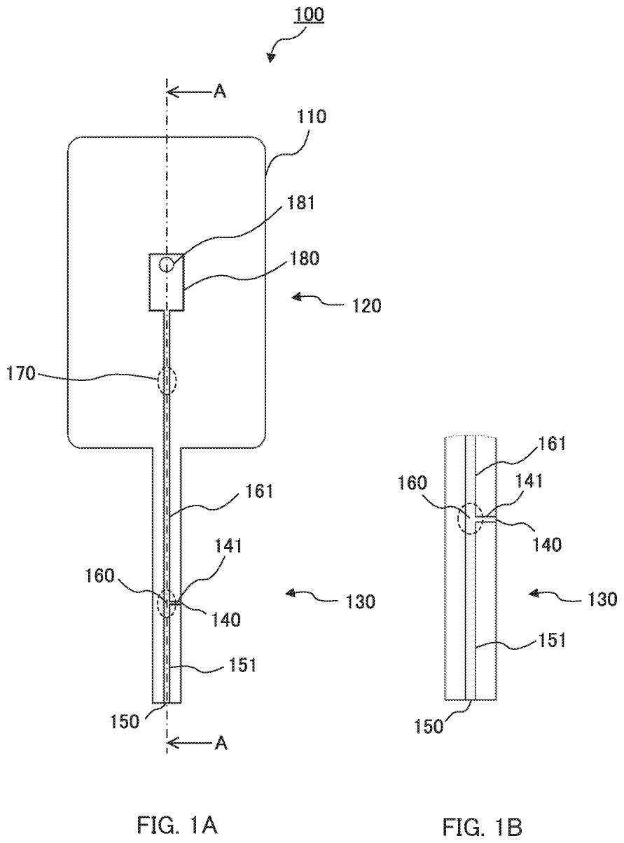

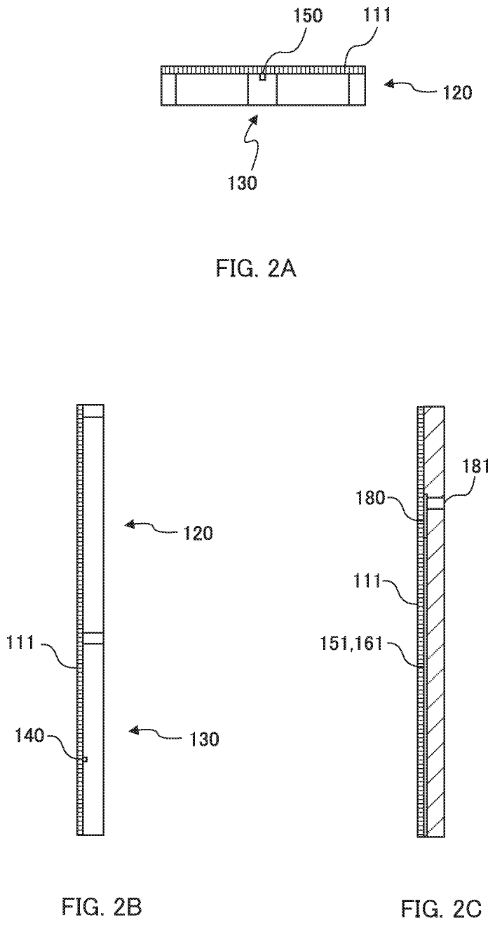

FIGS. 1A to 2C illustrate fluid handling device 100 according to embodiment 1 of the present invention. FIG. 1A is a plan view of fluid handling device 100. FIG. 1B is a partially enlarged view of immersion part 130 of fluid handling device 100. FIGS. 1A and 1B omit film 111 to show the structure of the channels inside. FIG. 2A is a front view of fluid handling device 100. FIG. 2B is a right side view of fluid handling device 100. FIG. 2C is a cross-sectional view taken along line A-A of FIG. 1A.

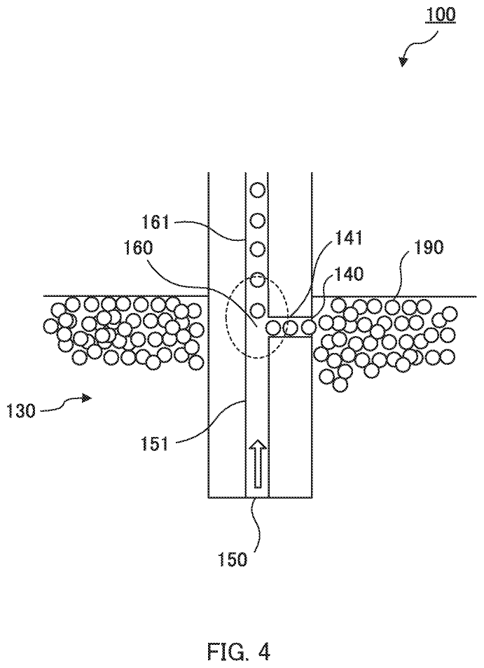

Fluid handling device 100 is for, from a mixed liquid in which particles 190 are gathered in a surface layer or a bottom layer in a liquid, arranging particles 190 in a line and allowing particles 190 to flow while separating particles 190 from each other (see FIG. 4). In addition, fluid handling device 100 can also measure various information (for example, presence/absence of amplification of DNA in the droplet) for each of particles 190 flowing in a line by performing fluorescence observation or the like in detection part 170 (described below) on the channel.

The type of particle 190 is not limited. Particle 190 is a droplet or a cell in the present embodiment. A droplet as particle 190 may contain a biological substance such as a nucleic acid, a protein or a complex thereof. Alternatively, a droplet may include a reagent for processing a biological substance (for example, a reagent for performing digital PCR), a reagent for detecting a biological substance, or the like. Examples of such reagents include primers for amplifying a specific region of a nucleic acid, (displacement) polymerases, salts, buffers for pH adjustment, nucleotides, fluorescent dyes that can bind to nucleic acids, and diluents. The type of the particle as a cell is not limited, either. Examples of the cells include tissue-derived cells, blood-derived cells, cancer cells and cultured cells.

The type of the liquid is not limited as long as it can function as a dispersion medium for particles 190. Examples of the liquid include various oils which are in a liquid form at room temperature, such as mineral oils and silicone oils for particles 190 as droplets. Examples of the liquid include buffers and liquid media for particles 190 as cells.

As illustrated in FIGS. 1A to 2C, fluid handling device 100 includes substrate 110 in which linear grooves, a substantially rectangular recess and a substantially cylindrical through hole are formed, and film 111 disposed on one of the surfaces of substrate 110 so as to cover the recess and openings of the grooves. As described below, covering the openings of the grooves formed in substrate 110 by the film forms particle channel 141, liquid channel 151 and joining channel 161 (all of which will be described below). Covering the opening of the substantially rectangular recess formed in substrate 110 by the film forms particle storage 180 (described below).

The material of substrate 110 is not limited as long as it can obtain a desired shape and does not deteriorate when it is brought into contact with the mixed liquid. The material is, for example, a resin. Examples of the resin constituting substrate 110 include polyethylene terephthalate, polycarbonate, polymethylmethacrylate, vinyl chloride, polypropylene, polyether and polyethylene. In addition, the thickness of substrate 110 is not limited as long as the channels and the like can be appropriately formed, and necessary strength can be obtained. The thickness of substrate 110 is, for example, about 1 to 10 mm.

The material of film 111 is not limited as long as it does not deteriorate when it is brought into contact with the mixed liquid, and is, for example, a resin. For performing fluorescence observation or the like in detection part 170 (described below) on the channel, the material of film 111 needs to transmit light of a predetermined wavelength. In addition, the thickness of film 111 is not limited as long as the channels and the like can be appropriately formed, and necessary strength can be obtained. The thickness of the film is, for example, about 100 to 500 μm.

As illustrated in FIG. 1A, fluid handling device 100 includes grip part 120 for being held by a user or other instrument, and immersion part 130, protruding from grip part 120, to be immersed in a liquid. The shapes and the sizes of grip part 120 and immersion part 130 are not limited as long as the above-described object can be achieved. A mixed liquid containing particles 190 and a liquid may be stored in a small container, and thus immersion part 130 preferably has an elongated shape that can be inserted into such a small container. For example, the width of immersion part 130 (the length in the horizontal direction when immersed) is about 0.5 mm to 10 mm, and the length of immersion part 130 (the length in the vertical direction when immersed) is about 0.5 to 100 mm.

As illustrated in FIGS. 1A and 1B, fluid handling device 100 includes particle intake port 140, particle channel 141, liquid intake port 150, liquid channel 151, junction 160, joining channel 161, detection part 170, particle storage 180 and particle collection port 181.

Particle intake port 140 is an opening which is for taking in particles and opens onto the surface of immersion part 130. Particle intake port 140 is disposed so as to be located above or below liquid intake port 150 when immersion part 130 is immersed in a liquid. In the present embodiment, particle intake port 140, which is disposed above liquid intake port 150, takes in particles 190 (for example, droplets) gathered in the surface layer of a liquid and guides the particles to particle channel 141 (see FIG. 4).

The opening area and shape of particle intake port 140 are not limited as long as particles 190 can be taken in. The opening area of particle intake port 140 is, for example, about 100 μm² to 2 mm². When the diameter of particles is 100 μm, the opening area of particle intake port 140 is, for example, about 6,400 to 14,400 μm². The shape of particle intake port 140 is substantially rectangular.

Particle channel 141 is configured to allow particles 190 taken in from particle intake port 140 to flow to junction 160 with liquid channel 151. Particle channel 141 joins with liquid channel 151 to form junction 160 (see FIG. 1B). The shape of particle channel 141 is not limited, and particle channel 141 is linear in the present embodiment. The shape and size of the cross section of particle channel 141 are not limited as long as particles 190 can flow through particle channel 141. The width of particle channel 141 is, for example, about 10 μm to 2 mm, and the depth of particle channel 141 is, for example, about 10 to 500 μm.

Liquid intake port 150 is an opening that opens onto the surface of immersion part 130 for taking in a liquid. This liquid is for separating particles 190 from each other, which are taken in from particle intake port 140. Liquid intake port 150 is disposed so as to be located above or below particle intake port 140 when immersion part 130 is immersed in a liquid. In the present embodiment, liquid intake port 150 is disposed below particle intake port 140.

The opening area of liquid intake port 150 is not limited. When the opening area of liquid intake port 150 is smaller than the cross-sectional area of a particle, the particle is less likely to be sucked into liquid intake port 150. In the present invention, the term “cross-sectional area of particle (hereinafter also referred to as “particle cross-sectional area”)” refers to the largest cross-sectional area among the particle cross-sectional areas (for example, when a particle is spherical, the particle cross-sectional area refers to the area of the particle cross section that cuts through the spherical center of the particle). The ratio of the opening area of liquid intake port 150 to the particle cross-sectional area is, for example, 1/3 to 3. The opening area of liquid intake port 150 may either be smaller or larger than the opening area of particle intake port 140. The opening area of liquid intake port 150 is, for example, within the range of 1/3 to 3 times the opening area of particle intake port 140. The shape of the opening of liquid intake port 150 is not limited as long as a liquid can be taken in. In the present embodiment, the shape of the opening of liquid intake port 150 is substantially rectangular.

Liquid channel 151 is configured to allow the liquid taken in from liquid intake port 150 to flow. Liquid channel 151 joins with particle channel 141 to form junction 160 (see FIG. 1B). The shape of liquid channel 151 is not limited, and liquid channel 151 is linear in the present embodiment. The shape and size of the cross section of liquid channel 151 are not limited as long as a liquid can flow through liquid channel 151. The width of liquid channel 151 is, for example, about 10 to 500 μm, and the depth of liquid channel 151 is, for example, about 10 to 500 μm. The cross-sectional area of liquid channel 151 is not limited. In the present invention, “cross-sectional area of liquid channel” refers to the cross-sectional area of the liquid channel when it is cut along a cross section perpendicular to the flow direction of a fluid in the liquid channel. Changing the cross-sectional area of liquid channel 151 can adjust the below-described separation distance between particles. For example, when the flow rate of a liquid to be introduced into liquid channel 151 is constant, a smaller cross-sectional area of liquid channel 151 tends to make the below-described separation distance between particles larger, and a larger cross-sectional area of liquid channel 151 tends to make the below-described separation distance between particles smaller.

Junction 160 is a site where particle channel 141 and liquid channel 151 join. In junction 160, a liquid flowing from liquid channel 151 separates particles 190 flowing from particle channel 141 from each other. Particles 190 separated at constant intervals are sent to joining channel 161 by a liquid flowing from particle channel 141 and a liquid flowing from liquid channel 151. The angle between particle channel 141 and liquid channel 151 at junction 160 is not limited. The angle between particle channel 141 and liquid channel 151 is, for example, about 60 to 120°. In the present embodiment, particle channel 141 opens onto the side surface of liquid channel 151 at junction 160. For particles 190 to reach junction 160 one by one, the opening of particle channel 141 at junction 160 preferably has a size such that more than one particle 190 cannot pass through simultaneously (i.e., at the same time), in other words, a size such that only one particle 190 can pass through (see FIG. 4). The size of the opening of particle channel 141 at junction 160 is, for example, about 10 to 500 μm.

Joining channel 161 is disposed downstream of junction 160. At junction 160, joining channel 161 is configured to allow particles 190 that are separated at constant intervals to flow in a state where the particles are arranged in a line (see FIG. 4). The shape of joining channel 161 is not limited, and joining channel 161 is linear in the present embodiment. The cross-sectional area of joining channel 161 is not limited as long as particles 190 can flow in a state where the particles are arranged in a line, and may be set appropriately according to the size of the particles. The width of joining channel 161 is, for example, about 20 to 500 μm, and the depth of joining channel 161 is, for example, about 10 to 500 μm.

Detection part 170 may be provided on joining channel 161. Detection part 170 can measure various information (for example, presence/absence of amplification of DNA in the droplet) for each of particles 190 flowing in a line by performing fluorescence observation or the like.

Particle storage 180, which is connected to joining channel 161, is a space of substantially rectangular shape for storing particles 190 flowing through joining channel 161. The size and shape of particle storage 180 are not limited.

Particle collection port 181 is a through hole connecting particle storage 180 and the outside. In the present embodiment, particle collection port 181 opens onto one of the two surfaces of substrate 110, where a film is not disposed. A pump or the like may be connected to particle collection port 181. The shape and size of particle collection port 181 are not limited as long as particles 190 can pass through. In the present embodiment, the shape of particle collection port 181 is cylindrical.

(Method for Using Fluid Handling Device)

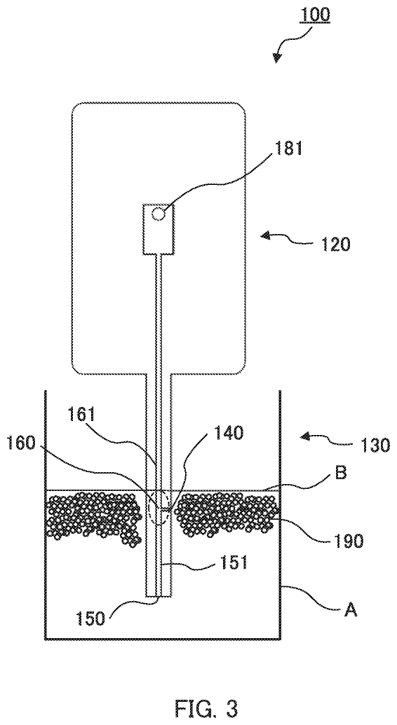

Hereinafter, a method for using fluid handling device 100 will be described. FIG. 3 illustrates the usage state of fluid handling device 100 according to the present embodiment. FIG. 4 is a partially enlarged view illustrating the usage state of fluid handling device 100. These examples make the description on the assumption that particles 190 are gathered in the surface layer in a liquid.

As illustrated in FIGS. 3 and 4, immersion part 130 is inserted into small container A that stores a mixed liquid containing particles 190 and a liquid. Grip part 120 is fixed in such a manner that particle intake port 140 is located in the group of particles 190 gathered near interface B of the liquid, and liquid intake port 150 is located in the liquid below the group of particles 190. A pump (not illustrated) connected to the opening of particle collection port 181 is then operated. Suction inside the channel with a pump allows particles 190 to be taken in from particle intake port 140 and to reach junction 160 through particle channel 141. At the same time, the liquid is taken in from liquid intake port 150 and reaches junction 160 through liquid channel 151.

During the procedure, particles 190 are arranged in a line at junction 160 and are separated from each other by the liquid flowing through liquid channel 151. Particles 190 flow toward the downstream side (in the direction toward particle collection port 181) in joining channel 161 while maintaining this state. When a detection device is disposed so as to face detection part 170, various information (for example, presence/absence of amplification of DNA in the droplet) can be measured for particles 190 while immersion part 130 is still inside container A containing particles 190 and the liquid. During the detection, particles 190 flow in a line while being separated from each other in joining channel 161. Particles 190 reaching particle storage 180 are taken out through particle collection port 181.

(Effects)

As described above, fluid handling device 100 according to the present embodiment does not need to move particles 190 (for example, droplets) with a pipette or the like, and thus the destruction and loss of particles 190 can be suppressed. In addition, fluid handling device 100 according to the present embodiment can collect, align, and separate particles 190 from each other without using a glass tube, a connecting tube or the like, and thus fluid handling device 100 can be made smaller than conventional devices. Further, the liquid contained in the container that also contains particles 190 can be used without separately preparing a liquid for separating particles 190 from each other in fluid handling device 100 according to the present embodiment, and thus particles 190 can be collected, aligned, and separated from each other without using a new liquid.

### Embodiment 2

(Configuration of Fluid Handling Device)

Fluid handling device 200 according to embodiment 2 differs from fluid handling device 100 according to embodiment 1 only in that fluid handling device 200 further includes particle guiding channel 210. The same components as those of fluid handling device 100 according to embodiment 1 are designated by the same reference numerals, and the description thereof will be omitted.

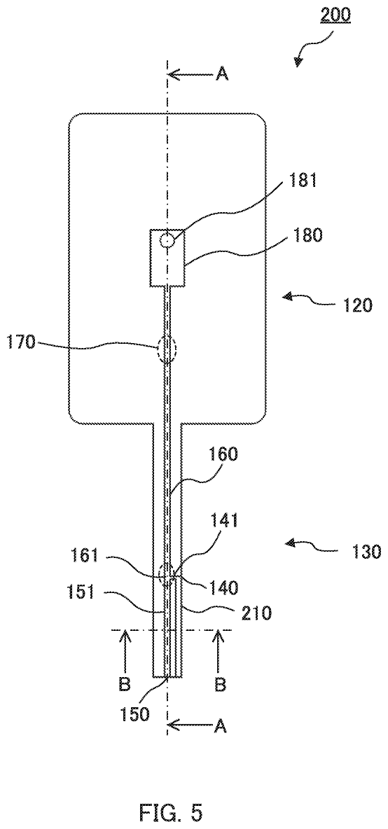

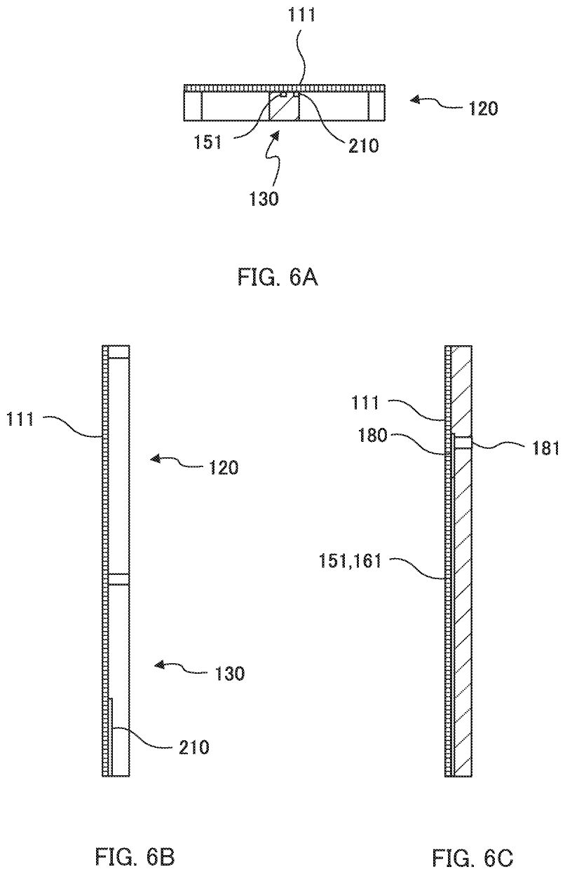

FIG. 5 is a plan view of fluid handling device 200 including particle guiding channel 210. FIG. 5 omits film 111 to show the structure of the channels inside. FIG. 6A is a cross-sectional view taken along line B-B of FIG. 5. FIG. 6B is a right side view of fluid handling device 200. FIG. 6C is a cross-sectional view taken along line A-A of fluid handling device 200. As illustrated in FIGS. 5 to 6C, particle intake port 140 is disposed so as to be located above liquid intake port 150 in a liquid in fluid handling device 200 according to the present embodiment when immersion part 130 is immersed.

As illustrated in FIG. 5, particle guiding channel 210 is disposed on the surface of immersion part 130 so as to extend in the vertical direction when immersion part 130 is immersed in a liquid, and so as to be connected to particle intake port 140. Particle guiding channel 210 guides particles 190 to particle intake port 140 using the capillary phenomenon even when particle intake port 140 is located above interface B of the liquid. In the present embodiment, particle guiding channel 210 is a groove provided on the right side surface of substrate 110 in immersion part 130. Film 111 does not cover the opening of this groove. The width and depth of particle guiding channel 210 are not limited as long as the above-described object can be achieved. The width of particle guiding channel 210 is, for example, about 10 to 500 μm, and the depth of particle guiding channel 210 is, for example, about 10 to 500 μm.

(Method for Using Fluid Handling Device)

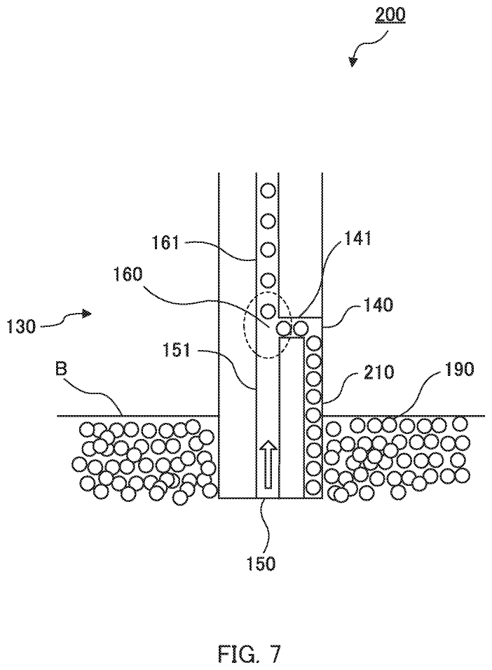

Hereinafter, a method for using fluid handling device 200 will be described. FIG. 7 is a partially enlarged view illustrating the usage state of fluid handling device 200. This example makes the description on the assumption that particles 190 are gathered in the surface layer in a liquid.

As illustrated in FIG. 7, immersion part 130 is inserted into small container A that stores a mixed liquid containing particles 190 and a liquid, and a pump is then operated. This procedure can arrange particles 190 in a line while separating particles 190 one by one with the liquid from liquid channel 151 and allow particles 190 to flow in joining channel 161 toward the downstream side as described in embodiment 1. As the liquid is taken in from liquid intake port 150, interface B is lowered, and accordingly, the location of particles 190 gathered in the surface layer is also lowered. After a certain amount of time has passed, particle intake port 140 is thus located above interface B. When particle intake port 140 is located above interface B, particle guiding channel 210 guides particles 190 located below particle intake port 140 to particle intake port 140. Therefore, fluid handling device 200 according to the present embodiment can continue operating without moving fluid handling device 200 even when interface B is lowered.

(Effects)

In addition to the effect of fluid handling device 100 according to embodiment 1, fluid handling device 200 according to the present embodiment can continue operating even when the liquid is reduced and particle intake port 140 is thus located above interface B of the liquid.

### Embodiment 3

(Configuration of Fluid Handling Device and Method for Using Fluid Handling Device)

Fluid handling device 300 according to embodiment 3 differs from fluid handling device 200 according to embodiment 2 only in the configuration of particle guiding channel 320. The same components as those of fluid handling apparatus 100 according to embodiment 1 or fluid handling apparatus 200 according to embodiment 2 are designated by the same reference numerals, and the description thereof will be omitted.

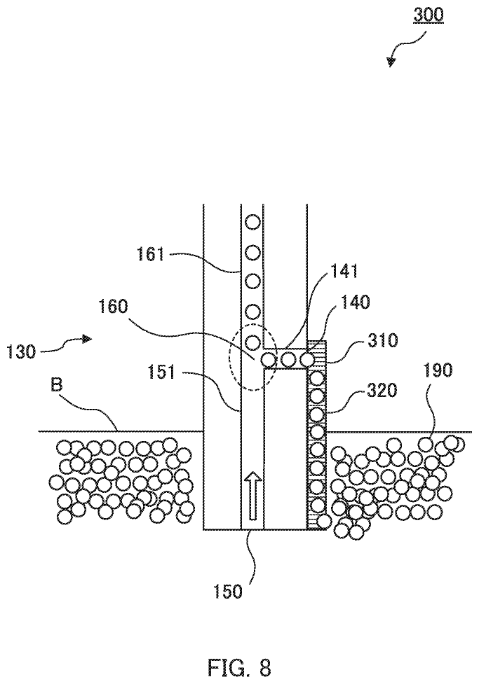

FIG. 8 is a partially enlarged view illustrating the configuration and usage state of fluid handling device 300. As illustrated in FIG. 8, film 310 is bonded to one of the surfaces of substrate 110 in fluid handling device 300 according to the present embodiment, but a part of film 310 is not bonded to substrate 110 and protrudes at the tip portion of immersion part 130. More specifically, film 310 protrudes from substrate 110 in a region, at the side surface (right side surface) where particle intake port 140 of immersion part 130 opens onto, from the tip of immersion part 130 to particle intake port 140. The side surface of substrate 110 and the protrusion of film 310 thus form particle guiding channel 320. It can be considered that particle guiding channel 320 is disposed on the surface of immersion part 130 so as to extend in the vertical direction when immersion part 130 is immersed in a liquid, and so as to be connected to particle intake port 140.

Fluid handling device 300 according to the present embodiment may be used in the same manner as fluid handling device 200 according to embodiment 2.

(Effects)

Fluid handling device 300 according to the present embodiment has the same effects as fluid handling device 200 according to embodiment 2.

### Embodiment 4

(Configuration of Fluid Handling Device)

Fluid handling device 400 according to embodiment 4 differs from fluid handling device 100 according to embodiment 1 in the positional relationship between particle intake port 410 and liquid intake port 420. The same components as those of fluid handling apparatus 100 according to embodiment 1 are designated by the same reference numerals, and the description thereof will be omitted.

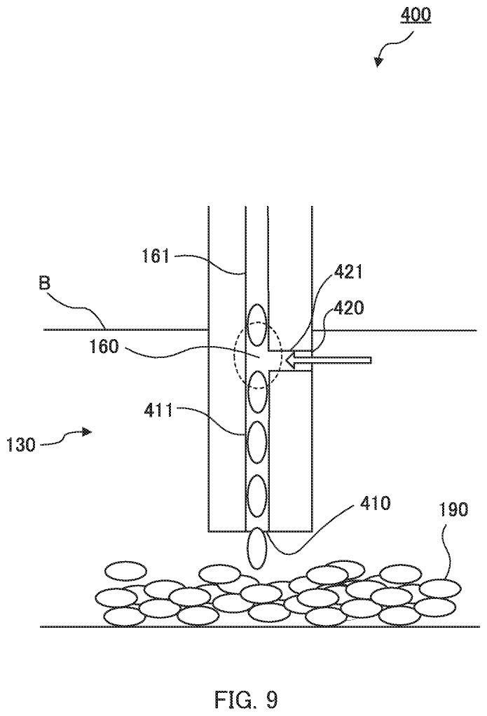

FIG. 9 is a partially enlarged view illustrating the configuration and usage state of fluid handling device 400. This example makes the description on the assumption that particles 190 are gathered in the bottom layer in a liquid. As illustrated in FIG. 9, particle intake port 410 is disposed so as to be located below liquid intake port 420 when immersion part 130 is immersed in a liquid in fluid handling device 400 according to embodiment 4. Particle intake port 410 takes in particles 190 (for example, cells) gathered in the bottom layer of a liquid and guides the particles to particle channel 411. Liquid intake port 420 is disposed so as to be located above particle intake port 410 when immersion part 130 is immersed in the liquid. Liquid intake port 420 takes in a liquid for separating particles 190 from each other which are taken in from particle intake port 410, and guides the liquid to liquid channel 421.

(Method for Using Fluid Handling Device)

Hereinafter, a method for using fluid handling device 400 will be described. As illustrated in FIG. 9, immersion part 130 is inserted into small container A that stores a mixed liquid containing particles 190 and a liquid. Grip part 120 is fixed in such a manner that particle intake port 410 is located in the group of particles 190 gathered in the bottom layer of the liquid, and liquid intake port 420 is located in the liquid above the group of particles 190. A pump (not illustrated) connected to the opening of particle collection port 181 is then operated. Suction inside the channel with a pump allows particles 190 to be taken in from particle intake port 410 and reach junction 160 through particle channel 411. At the same time, the liquid is taken in from liquid intake port 420 and reaches junction 160 through liquid channel 421.

During the procedure, particles 190 are arranged in a line at junction 160 and are separated from each other by the liquid flowing through liquid channel 421. Particles 190 flow toward the downstream side (in the direction toward particle collection port 181) in joining channel 161 while maintaining this state. When a detection device is disposed so as to face detection part 170, various information (for example, presence/absence of specific protein in cells) can be measured for particles 190 while immersion part 130 is still inside container A containing particles 190 and the liquid. During the detection, particles 190 flow in a line while being separated from each other in joining channel 161. Particles 190 reaching particle storage 180 are taken out through particle collection port 181.

(Effects)

Fluid handling device 400 according to the present embodiment has the same effects as fluid handling device 100 according to embodiment 1.

[Modifications]

The above embodiments describe fluid handling devices 100, 200, 300 and 400 each having one liquid flow channel 151 or 421, but the fluid handling device according to the present invention may include more than one liquid channel. The liquid channels in this case may individually join particle channels at different positions. Adjusting the number and individual cross-sectional areas of the liquid channels can adjust the separation distance between particles. For example, providing liquid channels each having a cross-sectional area smaller than the cross-sectional area of a particle channel can adjust the separation distance of particles.

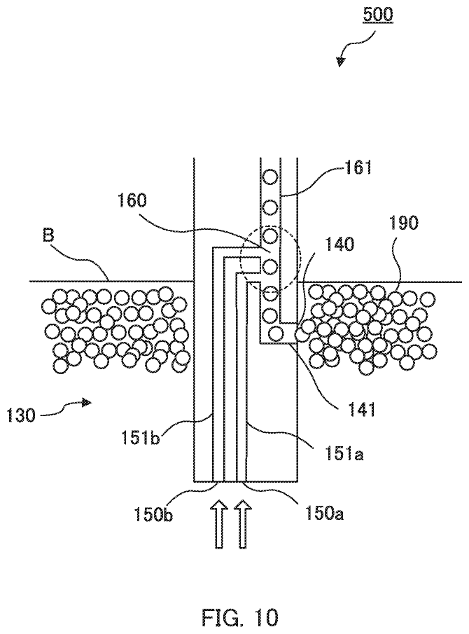

FIG. 10 is a partially enlarged view illustrating the configuration of fluid handling device 500 including more than one liquid channel according to the modification. Fluid handling device 500 may be used when particles 190 are gathered in the surface layer in a liquid. As illustrated in FIG. 10, fluid handling device 500 differs from fluid handling device 100 according to embodiment 1 in that fluid handling device 500 includes liquid intake ports 150a and 150b, and liquid channels 151a and 151b. Each of liquid intake ports 150a and 150b preferably has a size such that particle 190 cannot pass through.

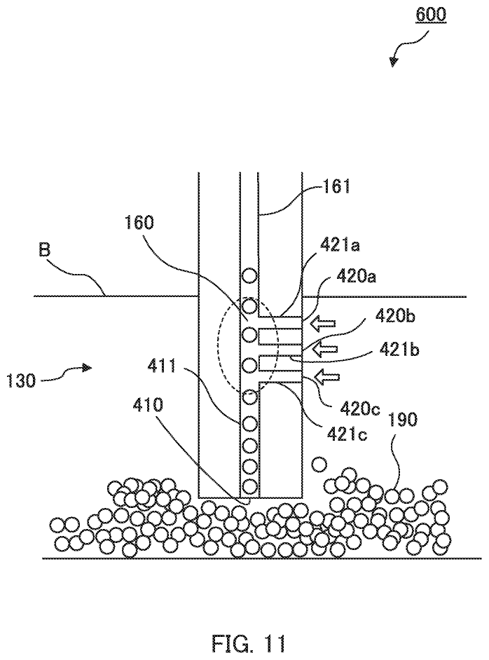

FIG. 11 is a partially enlarged view illustrating the configuration of fluid handling device 600 including more than one liquid channel according to the modification. Fluid handling device 600 may be used when particles 190 are gathered in the bottom layer in a liquid. As illustrated in FIG. 11, fluid handling device 600 differs from fluid handling device 400 according to embodiment 4 in that fluid handling device 600 includes liquid intake ports 420a, 420b and 420c, and liquid channels 421a, 421b and 421c. Each of liquid intake ports 420a, 420b and 420c preferably has a size such that particle 190 cannot pass through.

This application claims priority based on Japanese Patent Application No. 2018-059925, filed on Mar. 27, 2018, the entire contents of which including the specification and the drawings are incorporated herein by reference.

### INDUSTRIAL APPLICABILITY

The fluid handling device according to the present invention is particularly advantageous as a device used in, for example, clinical analyses.

### REFERENCE SIGNS LIST

100, 200, 300, 400, 500, 600 Fluid handling device
110 Substrate
111, 310 Film
120 Grip part
130 Immersion part
140, 410 Particle intake port
141, 411 Particle channel
150, 150a, 150b, 420, 420a, 420b, 420c Liquid intake port
151, 151a, 151b, 421, 421a, 421b, 421c Liquid channel
160 Junction
161 Joining channel
170 Detection part
180 Particle storage
181 Particle collection port
190 Particle
210, 320 Particle guiding channel
A Container
B Interface

1. A fluid handling device for, from a mixed liquid with particles gathered in a surface layer or a bottom layer of a liquid, arranging the particles in a line and allowing the particles to flow while the particles are separated from each other, the fluid handling device comprising:
an immersion part to be immersed in the liquid;
a particle intake port for taking in the particles, the particle intake port opening onto a surface of the immersion part;
a liquid intake port for taking in the liquid, the liquid intake port opening onto the surface of the immersion part;
a particle channel for allowing the particles taken in from the particle intake port to flow;
a liquid channel for allowing the liquid taken in from the liquid intake port to flow;
a junction of the particle channel and the liquid channel; and
a joining channel for allowing the particles to flow in a state where the particles are arranged in the line, the joining channel being disposed downstream of the junction,
wherein
the particle intake port and the liquid intake port are disposed at different positions in a vertical direction when the immersion part is immersed in the liquid.

2. The fluid handling device according to claim 1, wherein the particle channel opens onto a side surface of the liquid channel at the junction.

3. The fluid handling device according to claim 1, wherein an opening of the particle channel at the junction has a size that does not allow the particles to pass through simultaneously.

4. The fluid handling device according to claim 1, wherein:
the particle intake port is disposed so as to be located above the liquid intake port when the immersion part is immersed in the liquid; and
the fluid handling device further includes a particle guiding channel for guiding the particles to the particle intake port, the particle guiding channel being disposed on the surface of the immersion part so as to extend in the vertical direction when the immersion part is immersed in the liquid and so as to be connected to the particle intake port.

5. The fluid handling device according to claim 1, wherein the particles are droplets or cells.

6. The fluid handling device according to claim 1, further comprising a detection part for detecting the particles, the detection part being disposed on the joining channel.
